(19) United States
(12) Patent Application Publication
(10) Pub. No.: US 2013/0103868 A1
(43) Pub. Date: Apr. 25, 2013

(54) INTEGRATED CIRCUIT SYSTEM AND METHOD FOR OPERATING MEMORY SYSTEM

(71) Applicant: Seung-Min OH, Gyeonggi-do (KR)

(72) Inventor: Seung-Min OH, Gyeonggi-do (KR)

(21) Appl. No.: 13/610,107

(22) Filed: Sep. 11, 2012

(30) Foreign Application Priority Data
Oct. 25, 2011 (KR) 10-2011-0109345

(51) Int. Cl. G06F 13/42

(52) U.S. Cl. 710/110

(57) ABSTRACT

An integrated circuit system includes: a master chip; a slave chip configured to operate under a control of the master chip; and a data channel configured to transfer data between the master chip and the slave chip, wherein a data transfer rate from the master chip to the slave chip through the data channel is different from a data transfer rate from the slave chip to the master chip through the data channel.

### CROSS-REFERENCE TO RELATED APPLICATIONS

The present application claims priority of Korean Patent Application No. 10-2011-0109345, filed on Oct. 25, 2011, which is incorporated herein by reference in its entirety.

### BACKGROUND

1. Field

Exemplary embodiments of the present invention relate to an integrated circuit system, and more particularly, to a technology for efficiently transfer data between chips.

2. Description of the Related Art

Integrated circuit chips may not operate alone and they operate by transferring and receiving data or signal to and from other chips. For example, memory chips such as a Dynamic Random Access Memory (DRAM) device and a flash memory device transfer and receive data to and from a controller, and a Central Processing Unit (CPU) also transfers and receives data to and from diverse chips in a system. As technology advances, the data transfer rate between chips is growing faster and the fast data transfer rate may generate noises and cause concerns in data recognition.

FIG. 1 is a block diagram illustrating a memory controller chip and memory chips according to prior art.

Referring to FIG. 1, the memory controller chip 110 operates by transferring and receiving data to and from a plurality of memory chips 121 to 128. Data channels between the respective memory chips 121 to 128 and the memory controller chip 110 are illustrated as 32-bit data channels.

When data are transferred from the memory controller chip 110 to the memory chips 121 to 128, the data are transferred through a 256-bit data channel. Although each of the memory chips 121 to 128 are coupled to a data channel of 32 bits, the memory controller chip 110 is coupled to a data channel of 256 bits. Therefore, tremendous noise may be generated when 256-bit data are transferred in the memory controller chip 110. The noise causes some concerns such as data recognition failure when data are transferred between the memory chips 121 to 128 and the memory controller chip 110.

Such concerns may occurs when data are transferred between the memory chips 121 to 128 and the memory controller chip 110 as well as when one chip transfers and receives data to and from a plurality of other chips.

### SUMMARY

An embodiment of the present invention is directed to devices to improve detoriation such as noise generation and data recognition failure when data are transferred between chips.

In accordance with an embodiment of the present invention, an integrated circuit system includes a master chip; a slave chip configured to operate under a control of the master chip; and a data channel configured to transfer data between the master chip and the slave chip, wherein a data transfer rate from the master chip to the slave chip through the data channel is different from a data transfer rate from the slave chip to the master chip through the data channel.

In accordance with another embodiment of the present invention, an integrated circuit system includes a first chip; a plurality of second chips; and a plurality of data channels configured to transfer data between the first chip and the multiple second chips, respectively, wherein a data transfer rate from the second chips to the first chip through the multiple data channels is different from a data transfer rate from the first chip to the second chips through the data channels.

In accordance with another embodiment of the present invention, a method for operating a memory system includes transferring a write command and a write address from a memory controller to a memory; transferring a write data from the memory controller to the memory with a first frequency; transferring a read command and a read address from the memory controller to the memory; and transferring a read data from the memory to the memory controller with a second frequency that is different from the first frequency.

An integrated circuit system includes plural different types of devices; and a single type of data channels between the devices, wherein data transfers between the devices are performed at different rates according to transmission direction.

### BRIEF DESCRIPTION OF THE DRAWINGS

FIG. 1 is a block diagram illustrating a memory controller chip and memory chips according to prior art.

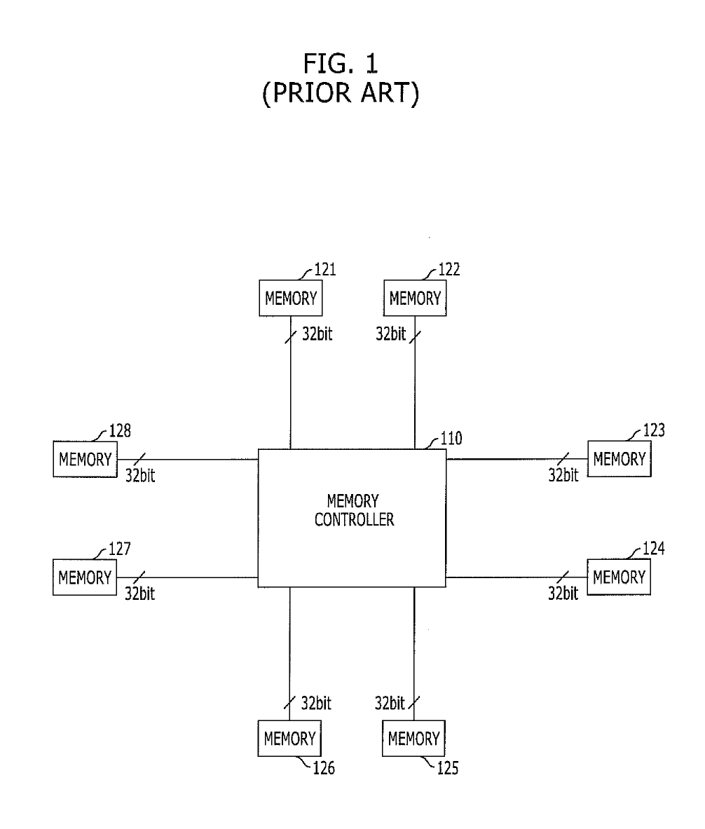

FIG. 2 is a block diagram illustrating an integrated circuit system including a first chip and a plurality of second chips in accordance with an embodiment of the present invention.

FIG. 3 is a block diagram illustrating an integrated circuit system for an asymmetrical data transfer between a first chip and a second chip shown in FIG. 2.

FIG. 4 is a block diagram illustrating a memory system in accordance with another embodiment of the present invention.

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

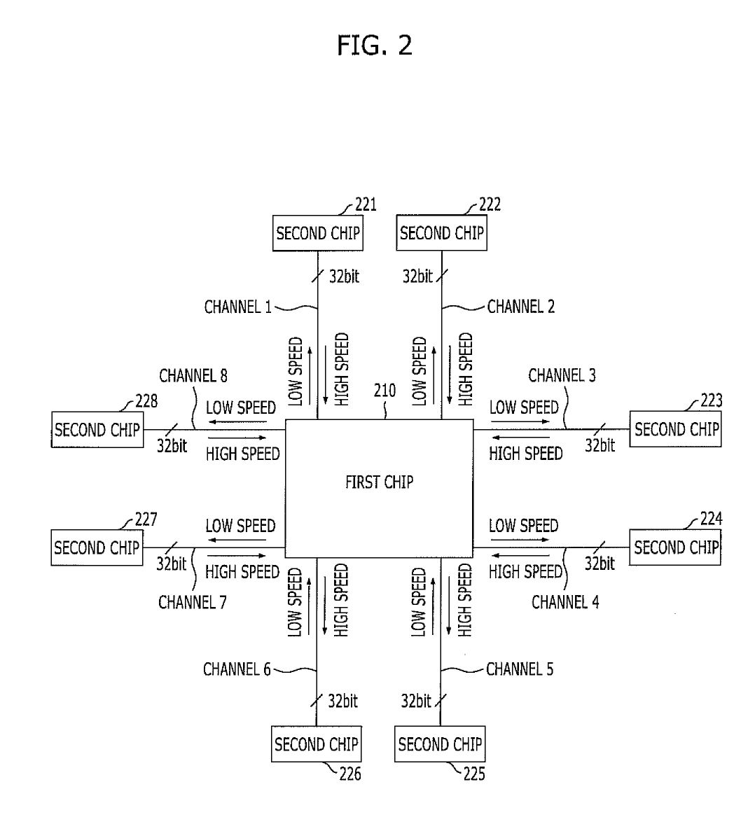

FIG. 2 is a bock diagram illustrating an integrated circuit system including a first chip and a plurality of second chips in accordance with an embodiment of the present invention.

Referring to FIG. 2, the integrated circuit system includes a first chip 210, a plurality of second chips 221 to 228, a plurality of channels CHANNEL1 to CHANNEL8 coupling the first chip 210 and the second chips 221 to 228 respectively. Each channel may be 32 bits.

The first chip 210 transfers and receives data to and from the second chips 221 to 228 through the channels CHANNEL1 to CHANNEL8, respectively. When data are transferred and received between one chip and other multiple chips, one chip, e.g., the first chip 210, serves as a master chip and the other multiple chips, e.g., the second chips 221 to 228, serve as slave chips which are subordinate to the master chip or under the control of the master chip. For example, the first chip 210 may be a memory controller, and the second chips 221 to 228 may be memories that operate under the control of the memory controller.

In this embodiment of the present invention, the aforementioned detorioration occurring in data transfer is solved by controlling the data transfer rate of the first chip 210 and the data transfer rate of the second chips 221 to 228 to be different from each other. For example, when data are transferred from the first chip 210 to the second chips 221 to 228, the data may be transferred at a low data transfer rate, which may be as low frequency as approximately 400 Mhz. When data are transferred from the second chips 221 to 228 to the first chip 210, the data may be transferred at a high data transfer rate, which may be as high frequency as approximately 500 Mhz.

The system may control upstream or downstream data transfer at different data transfer rates because of the following reasons. First, although a 32-bit data channel, which is respectively coupled to each of the 32-bit channels CHANNEL1 to CHANNEL8, is formed for each of the second chips 221 to 228, the first chip 210 is coupled to one 256-bit data channel CHANNEL1 to CHANNEL8. Additionally, when data are transferred and received, more noise is generated in a data transferring part than in a data receiving part. Generally, the data transferring part consumes more power than the data receiving part because of generating predetermined current amounts or voltage level corresponding to outputted data. On the other hand, the data receiving part just recognizes the data transferred through the data channel. Further, when data are transferred at a high data transfer rate, more noise is generated and more power is consumed as data are transferred faster.

When data are transferred from the first chip 210 to the second chips 221 to 228, a great amount of noise is generated in the first chip 210. Particularly, when a downstream data transfer rate from the first chip 210 to the second chips 221 to 228 is high, enormous noise may be generated at the first chip 210. Therefore, in the embodiment of the present invention, the downstream data transfer rate is controlled to be low while an upstream data transfer rate from the second chips 221 to 228 to the first chip 210 is controlled to be high. Of course, in the upstream data transfer, noise may be generated in the second chips 221 to 228. However, since the number of bits of each data channels coupled to the second chips 221 to 228, which is 32 bits, is much smaller than that of the data channel of the first chip 210, which is 256 bits, the noise might be insignificant.

In the downstream data transfer, the data are not always transferred to all of the second chips 221 to 228 simultaneously. That is, the data may be transferred to some of the second chips 221 to 228. Also, downstream data is transferred through some data channels, upstream data may be transferred through other data channels. While data are transferred from the first chip 210 to some of the second chips 221 to 228 through some data channels among the data channels CHANNEL1 to CHANNEL8, other data may be transferred from the other second chips to the first chip 210 through the other data channels.

The first chip 210 and the second chips 221 to 228 might be not required to be formed in one chip or one wafer. Those may be a chip package including plural chips inside. Although not illustrated in FIG. 2, a control channel may be provided for transferring diverse control signals. Further, a strobe channel may be provided for strobing data transferred to the data channels.

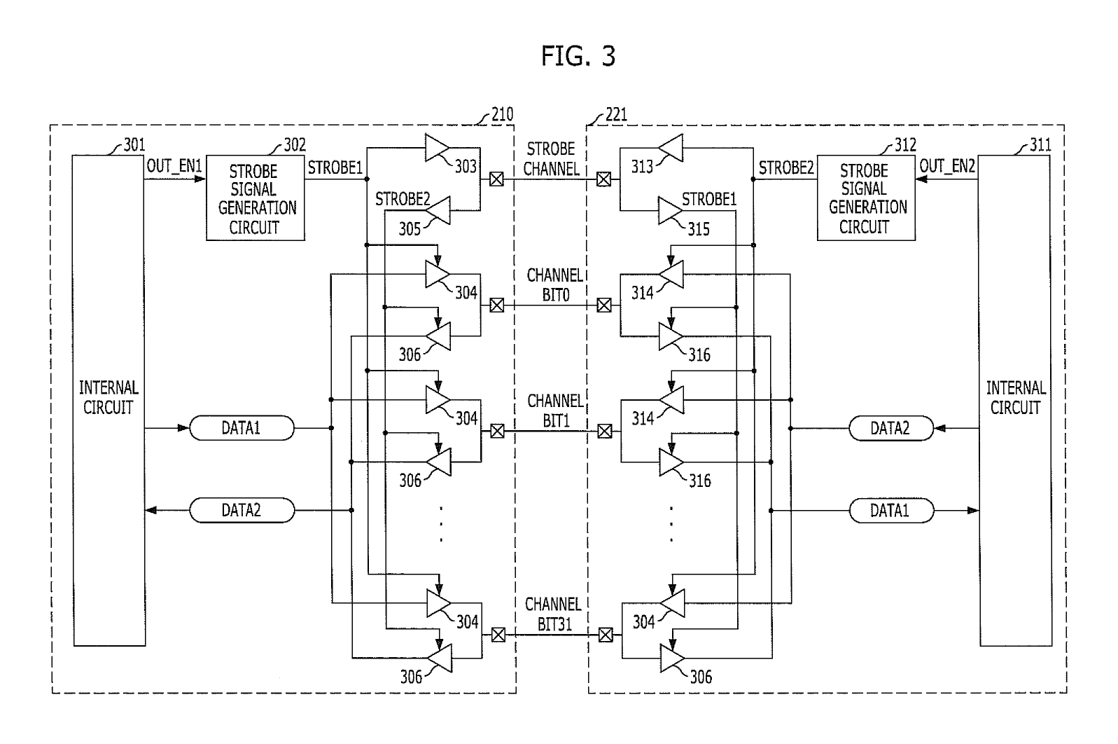

FIG. 3 is a block diagram illustrating an integrated circuit system for an asymmetrical data transfer between a first chip 210 and a second chip 221 shown in FIG. 2.

Referring to FIG. 3, the first chip 210 includes an internal circuit 301, a strobe signal generation circuit 302, a strobe signal transferring circuit 303, a data transferring circuit 304, a strobe signal receiving circuit 305, and a data receiving circuit 306.

The internal circuit 301 performs the intrinsic function of the first chip 210. The intrinsic function of the first chip 210 depends on what kind of chips the first chip 210 is. For example, if the first chip 210 is a memory controller, the internal circuit 301 may include a logic for controlling a memory. If the first chip 210 is a Central Processing Unit (CPU), the internal circuit 301 may include a circuit for controlling diverse operations and peripheral chips.

The strobe signal generation circuit 302 generates a strobe signal STROBE1 for strobing a data DATA1 that is outputted from the first chip 210. A signal OUT_EN1 inputted to the strobe signal generation circuit 302 is a signal for informing a duration that the data DATA1 is outputted from the first chip 210. In short, the signal OUT_EN1 represents a required duration that the data DATA1 is recognized, which is an enabling duration of the strobe signal generation circuit 302. The strobe signal STROBE1 generated by the strobe signal generation circuit 302 is a signal having a lower frequency than a strobe signal STROBE2. The strobe signal generation circuit 302 may include an oscillator for generating a periodic signal.

The data transferring circuit 304 transfers the data from the internal circuit 301 to the second chip 221 in response to the strobe signal STROBE1. The data transferring circuit 304 may include a plurality of drivers as shown in FIG. 3. Since the data transferring circuit 304 transfers the data DATA1 in response to the strobe signal STROBE1, the data transfer rate of the data DATA1 outputted from the data transferring circuit 304 may be decided based on the frequency of the strobe signal STROBE1.

The strobe signal receiving circuit 305 receives a strobe signal STROBE2 that is transferred from the second chip 221 through a strobe channel, and transfers the received strobe signal STROBE2 to the data receiving circuit 306. The data receiving circuit 306 then receives the data DATA2 that is transferred from the second chip 221 to the first chip 210 in response to the strobe signal STROBE2.

The second chip 221 includes an internal circuit 311, a strobe signal generation circuit 312, a strobe signal transferring circuit 313, a data transferring circuit 314, a strobe signal receiving circuit 315, and a data receiving circuit 316.

The internal circuit 311 performs the intrinsic function of the second chip 221. The intrinsic function of the second chip 221 depends on what kind of chips the second chip 221 is. For example, if the second chip 221 is a memory, the internal circuit 311 may be a circuit for storing data and a circuit for controlling the data storing circuit.

The strobe signal generation circuit 312 generates a strobe signal STROBE2 for strobing a data DATA2 that is outputted from the second chip 221. A signal OUT_EN2 inputted to the strobe signal generation circuit 312 is a signal for informing a duration that the data DATA2 is outputted from the second chip 221. In short, the signal OUT_EN2 represents a required duration that the data DATA2 is recognized, which is an enabling duration of the strobe signal generation circuit 312. The strobe signal STROBE2 generated by the strobe signal generation circuit 312 is a signal having a higher frequency than a strobe signal STROBE1. The strobe signal generation circuit 312 may include an oscillator for generating a periodic signal. Also, the strobe signal generation circuit 312 may be designed to generate a strobe signal based on either a clock transferred from the first chip 210 or signals inputted from the outside if not including an oscillator.

The data transferring circuit 314 transfers the data to be transferred from the internal circuit 311 to the first chip 210 in response to the strobe signal STROBE2. The data transferring circuit 314 may include a plurality of drivers as shown in FIG. 3. Since the data transferring circuit 314 transfers the data DATA2 in response to the strobe signal STROBE2, the data transfer rate of the data DATA2 outputted from the data transferring circuit 314 may be decided based on the frequency of the strobe signal STROBE2.

The strobe signal receiving circuit 315 receives a strobe signal STROBE1 that is transferred from the first chip 210 through a strobe channel, and transfers the received strobe signal STROBE1 to the data receiving circuit 316. The data receiving circuit 316 then receives the data DATA1 that is transferred from the first chip 210 to the second chip 221 in response to the strobe signal STROBE1.

In other words, according to the embodiment in FIG. 3, the data transfer rate of the first chip 210 and the data transfer rate of the second chip 221 may be different based on two signals having different frequencies, which are the strobe signal STROBE1 transferred from the first chip 210 and the strobe signal STROBE2 transferred from the second chip 221.

Although FIG. 3 illustrates a structure for transferring and receiving data to and from the second chip 221 among the internal constituent elements of the first chip 210, it is obvious to those skilled in the art that the first chip 210 includes a structure for transferring and receiving data to and from the other second chips 222 to 228 as well. The structure for transferring and receiving data to and from the other second chips 222 to 228 in the first chip 210 may be the same as the structure of the first chip 210 for transferring and receiving data to and from the second chip 221. Also, since the first chip 210 may transfer the same strobe signal STROBE1 to all of the second chips 221 to 228, there may be only one strobe signal generation circuit 302 in the first chip 210.

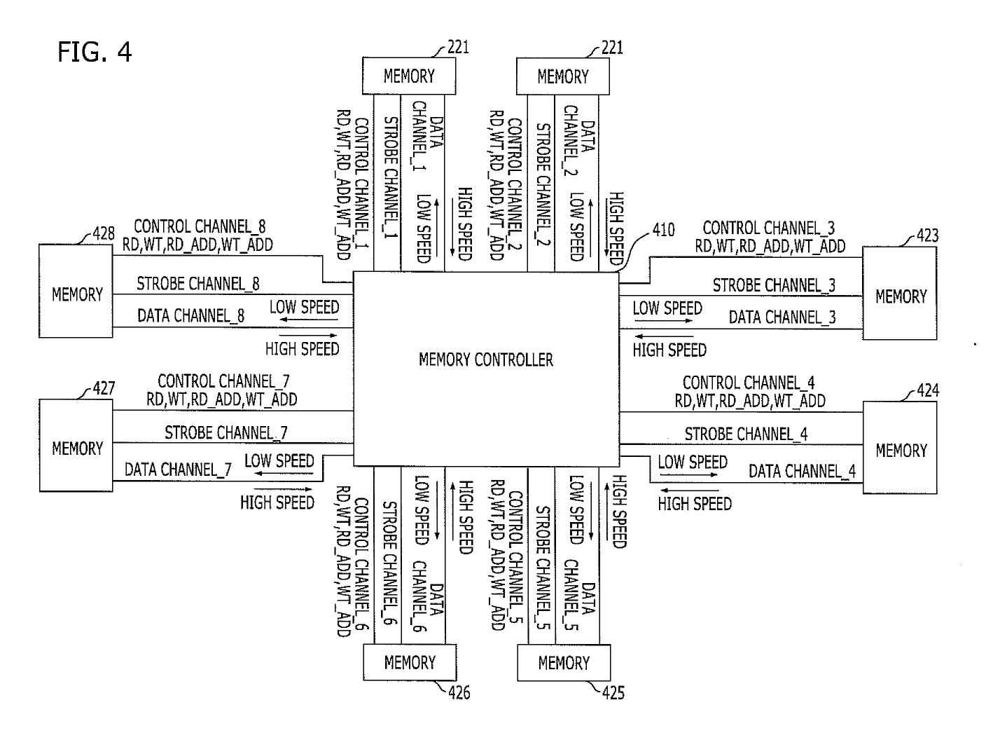

FIG. 4 is a bock diagram illustrating a memory system in accordance with an embodiment of the present invention. In the embodiment of FIG. 4, the first chip 210 of FIG. 2 is a memory controller and the second chips 221 to 228 are memories.

Referring to FIG. 4, the memory system includes a memory controller 410 and a plurality of memories 421 to 428. Data channels CHANNEL1 to CHANNEL8, strobe channels STROBE CHANNEL1 to STROBE CHANNEL8, and control channels CONTROL CHANNEL1 to CONTROL CHANNEL8 may be provided between the memory controller 410 and the memories 421 to 428. The control channels CONTROL CHANNEL1 to CONTROL CHANNEL8 transfer addresses and commands.

Hereafter, a write operation and a read operation that are performed between the memory controller 410 and the memories 421 to 428 is described with reference to FIG. 4.

During a write operation, a write command WT, which is also referred to as a program command in a flash memory operation, and a write address WT_ADD are transferred from the memory controller 410 to the memories 421 to 428 through the control channels CONTROL CHANNEL1 to CONTROL CHANNEL8. The memories 421 to 428 receive the write command WT and the write address WT_ADD and get themselves ready to receive data. Herein, the command and the address may be transferred through the data channels CHANNEL1 to CHANNEL8 in some kinds of memory devices such as a flash memory device.

Subsequently, data are transferred from the memory controller 410 to the memories 421 to 428 through the data channels CHANNEL1 to CHANNEL8. The memories 421 to 428 then program the data at an address designated by the write address WT_ADD. The data transferred from the memory controller 410 to the memories 421 to 428 are transferred at a low data transfer rate, as described earlier.

During a read operation, a read command RD and a read address RD_ADD are transferred from the memory controller 410 to the memories 421 to 428 through the control channels CONTROL CHANNEL1 to CONTROL CHANNEL8. The memories 421 to 428 receive the read command RD and the read address RD_ADD, read data at the address designated by the read address RD_ADD, and get themselves ready to transfer the read data to the memory controller 410.

Subsequently, the data are transferred from the memories 421 to 428 to the memory controller 410 through the data channels CHANNEL1 to CHANNEL8. The data transferred from the memories 421 to 428 to the memory controller 410 may be transferred at a high data transfer rate.

In the embodiment of the present invention, since the write data are transferred more slowly than the read data, the performance of the write operation may be relatively inferior to the performance of the read operation. However, such read/write operations prevent the generation of tremendous noise in the memory controller 410 and secure more stable performances. Also, since such scheme rather increases the possibility that the data transfer rate of the read data is raised, it may be understood that the overall performance is improved.

In a flash memory device, it takes much longer internal operation time for a write operation, which is also referred to as a program operation, than for a read operation. The difference in the internal operation times ranges from at least twice to more than tens of times. Also, in a Phase-Change Random Access Memory (PC RAM), it takes much longer internal operation time for a write operation than for a read operation. Therefore, although the data transfer rate of a write data is set to be slow, it scarcely affects the performance of the memory device.

According to an embodiment of the present invention, when data are transferred between one chip and a plurality of other chips, data are transferred at a low data rate from one chip to other chips, and data are transferred at a high data rate from the other chips to the one chip. Therefore, such problems as power noise and excessive current consumption in one chip which has to include many channels may be solved. As a result, the stable data transfer may be achieved.

While the present invention has been described with respect to the specific embodiments, it will be apparent to those skilled in the art that various changes and modifications may be made without departing from the spirit and scope of the invention as defined in the following claims.

What is claimed is:

1. An integrated circuit system, comprising:
a master chip;
a slave chip configured to operate under a control of the master chip; and
a data channel configured to transfer data between the master chip and the slave chip,
wherein a data transfer rate from the master chip to the slave chip through the data channel is different from a data transfer rate from the slave chip to the master chip through the data channel.

2. The integrated circuit system of claim 1, wherein the data transfer rate from the master chip to the slave chip is slower than the data transfer rate from the slave chip to the master chip.

3. An integrated circuit system, comprising:
a first chip;
a plurality of second chips; and
a plurality of data channels configured to transfer data between the first chip and the multiple second chips, respectively,
wherein a data transfer rate from the second chips to the first chip through the multiple data channels is different from a data transfer rate from the first chip to the second chips through the data channels.

4. The integrated circuit system of claim 3, wherein the data transfer rate from the first chip to the second chips is slower than the data transfer rate from the second chips to the first chip.

5. The integrated circuit system of claim 4, wherein the first chip is a memory controller, and the second chips are memories.

6. The integrated circuit system of claim 4, further comprising:
a plurality of strobe channels connecting the first chip and the second chips with each other, respectively,
wherein a frequency of a first strobe signal that is transferred from the first chip to the second chips through the multiple strobe channels is lower than a frequency of a second strobe signal that is transferred from each of the second chips to the first chip through the multiple strobe channels.

7. The integrated circuit system of claim 6, wherein the first chip transfers data in response to the first strobe signal and the second chips receive the data in response to the first strobe signal, and
the second chips transfer data in response to the second strobe signal and the first chip receives the data in response to the second strobe signal.

8. The integrated circuit system of claim 7, wherein the first chip comprises:
a first strobe signal generation circuit for generating the first strobe signal;
a first strobe signal transferring circuit for transferring the first strobe signal through the strobe channels;
a first data transferring circuit for transferring data through the data channels in response to the first strobe signal;
a first strobe signal receiving circuit for receiving the second strobe signal through the strobe channels; and
a first data receiving circuit for receiving data through the data channels in response to the second strobe signal.

9. The integrated circuit system of claim 8, wherein each of the second chips comprises:
a second strobe signal generation circuit for generating the second strobe signal;
a second strobe signal transferring circuit for transferring the second strobe signal through a strobe channel corresponding thereto among the multiple strobe channels;
a second data transferring circuit for transferring data through a data channel corresponding thereto among the data channels in response to the second strobe signal;
a second strobe signal receiving circuit for receiving the first strobe signal through a strobe channel corresponding thereto among the multiple strobe channels; and
a second data receiving circuit for receiving data through a data channel corresponding thereto among the multiple data channels in response to the first strobe signal.

10. The integrated circuit system of claim 9, wherein the second strobe signal generation circuit generates the second strobe signal based on a periodic wave that is transferred from the first chip.

11. A method for operating a memory system, comprising:
transferring a write command and a write address from a memory controller to a memory;
transferring a write data from the memory controller to the memory with a first frequency;
transferring a read command and a read address from the memory controller to the memory; and
transferring a read data from the memory to the memory controller with a second frequency that is different from the first frequency.

12. The method of claim 11, wherein the second frequency is higher than the first frequency.

13. An integrated circuit system, comprising:
plural different types of devices; and
a single type of data channels between the devices,
wherein data transfers between the devices are performed at different rates according to transmission direction.

14. The integrated circuit system of claim 13, wherein the devices includes a single first chip and plural second chips, and the data transfer from the first chip to the second chips is performed slower than the opposite-direction data transfer.

15. The integrated circuit system of claim 14, wherein the data transfer rate is determined based on the numbers of the same types of devices.
